(19) United States
(12) Patent Application Publication
(10) Pub. No.: US 2010/0306116 A1
(43) Pub. Date: Dec. 2, 2010

(54) System feasible duration evaluation method for project management under budget and time constraints

(75) Inventor: Yi-Kuei Lin, Taipei (TW)

Correspondence Address: BACON & THOMAS, PLLC, 625 SLATERS LANE, FOURTH FLOOR, ALEXANDRIA, VA, 22314-1176, US

(73) Assignee: National Taiwan University of Science and Technology, Taipei (TW)

(21) Appl. No.: 12/588,818

(22) Filed: Oct. 29, 2009

(30) Foreign Application Priority Data
May 27, 2009 (TW) 098117613

(51) Int. Cl. G06Q 10/00

(52) U.S. Cl. 705/301

(57) ABSTRACT

A system feasible duration evaluation method for project management under budget and time constraint is disclosed. The project includes plural arcs between a start node and a terminal node in a virtual network. The method includes the steps of providing a virtual network in a computer for simulating the project; inputting a plurality of activity, a budget constraint and a time constraint; distributing orderly the activity in the virtual network; defining a duration vector; checking if the activity duration satisfy the time constraint for dealing the activity in the duration vector of the minimal path; checking if the activity cost satisfy the budget constraint for dealing the activity in the duration vector; defining a upper duration vector; defining a lower duration vector; and listing the system feasible durations that satisfies the upper duration vector and the lower duration vector.

### BACKGROUND OF THE INVENTION

(1) Field of the Invention

The invention relates to a system feasible duration evaluation method for project management under budget and time constraints, and especially relates to a system feasible duration evaluation method for project management by applying the approaches in network analysis under budget and time constraints

(2) Description of the Prior Art

In the field of project management, program evaluation and review technique (PERT) and critical path method (CPM) are the most prominent procedure to manage a large-scale project. Said technique usually uses a graph of a virtual network denoting the relationships between activities of the project, so network analysis takes a place in the field of project management.

The virtual network of the project is modeled as the graph with nodes and arcs, to portray the interrelationships among the activities of a project. The project is represented in AOA (activity on arc) form or AON (activity on node) form. In AOA form, each arc denotes an activity of the project and each node denotes the state of the activity, and in AON form, arcs denote the relationships between activities and each node denotes an activity.

Traditionally, assuming the probability distribution of the activity duration (the period of the time needed to complete the activity) is a beta distribution in advance, three estimates (most likely estimate, most optimistic estimate and most pessimistic estimate) of activity duration are used, and the probability of the project time (the time required to complete the project) limited under time constraint is calculated. Wherein the activity duration is stochastic so the virtual network is called a stochastic network.

However, if the activity duration is not a beta distribution in practice, the conventional technique is hard to evaluate the project. When one activity is not completed in real time, the follow up is able to be effected and even the project is delayed. Hence, it is an important issue to schedule the system feasible duration in mobility.

### SUMMARY OF THE INVENTION

Accordingly, the object of the invention is to provide a system feasible duration evaluation method under budget and time constraints. With setting the constraint of the project time and the total cost for dealing the project between a start node and a terminal node in a flow network, listing the distribution of the feasible duration satisfied by the constraints to evaluate the quality of service for customer.

In one aspect, the invention provides a system feasible duration evaluation method for project management under budget and time constraints, using a computer containing an input unit, an operation unit and an output unit to execute a feasible duration evaluation software which provides a virtual network for simulating the project. The virtual network has a start node, a terminal node and plural arcs, whose unit is a duration, between nodes for constituting plural minimal paths.

The steps of said feasible duration evaluation method include: inputting a plurality of activities, a budget constraint and a time constraint from the input unit by users; distributing orderly the activities in the virtual network; defining a time vector composed of the durations of the arcs, and the durations which are stochastic to correspond with a distribution of the feasible durations in the project; executing a time check by the operation unit to checking if an activity duration of dealing each activity satisfies the time constraint for selecting the time vectors conforming the activity duration; executing a budget check by the operation unit to checking if a total cost of dealing all the activities satisfies the budget constraint for selecting the time vectors conforming the total cost; defining an upper boundary vector composed of the time vectors when all the activity durations equal to the time constraint and the total cost is less than the budget constraint; defining a lower boundary vector composed of the time vectors when the total cost equals to the budget constraint and the activity durations are less than the time constraint; and listing the time vectors of each minimal path in the virtual network less than or equaling to the upper boundary vector and larger than or equaling to the lower boundary vector, and defining a system feasible duration; and displaying the system feasible duration on the output unit.

In an embodiment, the steps of distributing orderly the activities in the virtual network include: listing the minimal paths of the virtual network, wherein each minimal path is required to be an sequence of the arcs between the start node to the terminal node without loops.

In an embodiment, the steps of executing a time check include: calculating the activity duration of dealing each of the activities in each minimal path; comparing the values of the activity durations and the time constraint; and according to the comparison result, judging if the time vector of the minimal path exists.

In an embodiment, the steps of executing a budget check include: calculating an activity cost of dealing each activity under time vector, and the total cost added the activity costs up; comparing the values of the total cost and the budget constraint; and according to the comparison result, judging if the time vector of the minimal path exists.

### BRIEF DESCRIPTION OF THE DRAWINGS

FIG. 1 is a schematic view of an embodiment of the virtual network for the project according to the present invention.

FIG. 2 is a block diagram of the hardware executing an embodiment of the system feasible duration evaluation method for project management under budget and time constraints according to the present invention.

FIG. 3 is a flow chart of the software executing an embodiment of the system feasible duration evaluation method for project management under budget and time constraints according to the present invention.

FIG. 4 is a schematic view of the relationship between the upper boundary vector and the lower boundary vector of the project.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

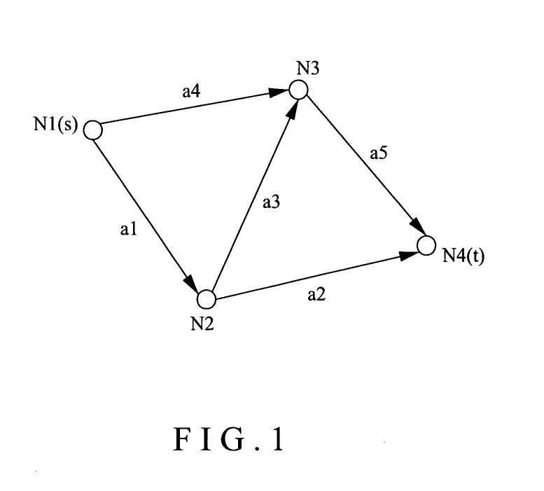

Refer to FIG. 1 for a virtual network with a start node s and a terminal node t. The virtual network represents the relationship between activities in a project, where N stands for all nodes, ai for all arcs, each arc ai connecting two nodes N. Each arc denotes an activity and the unit of the arc is a duration (the period of time needed) for completing the activity, and each node denotes the state of the activity.

The present invention provides a system feasible duration evaluation method for project management under budget and time constraints. The system feasible duration means all activities of the project completed under budget and time constraints. From the point of quality management, the system feasible duration of satisfying project completed in a specific time and budget is treated as a performance index of the service system.

For evaluating the system feasible duration of the project management, a computer is used in the present invention to run a feasible duration evaluation software which provides the virtual network for simulating the project.

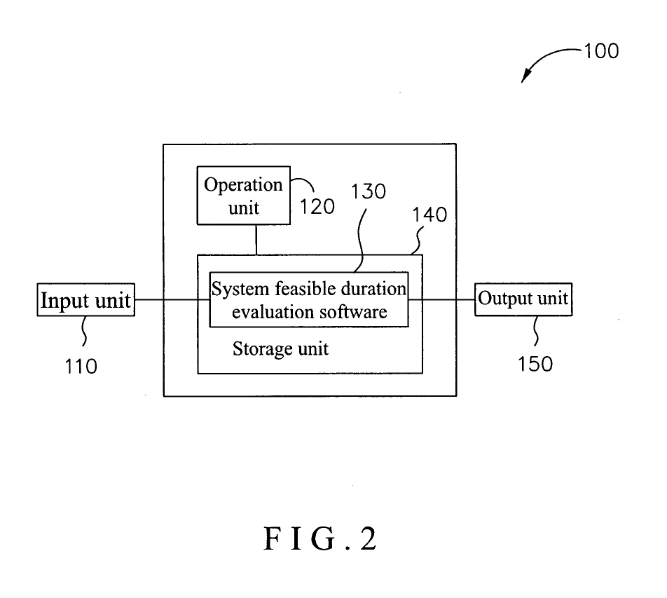

Refer to FIG. 2 for a block diagram of the hardware in the system feasible duration evaluation method for project management under budget and time constraints according to the present invention. A computer 100 has an input unit 110, an operation unit 120, a storage unit 140 and an output unit 150. The input unit 110, for example, is a keyboard or a handwriting input device. The operation unit 120, for example, is a central processing unit (CPU). The storage unit 140, for example, is a hardware electrically connected to the input unit 110, the operation unit 120 and the output unit 150. A system feasible duration evaluation software 130 is installed in the hardware. The output unit 150, for example, is a display or a printer.

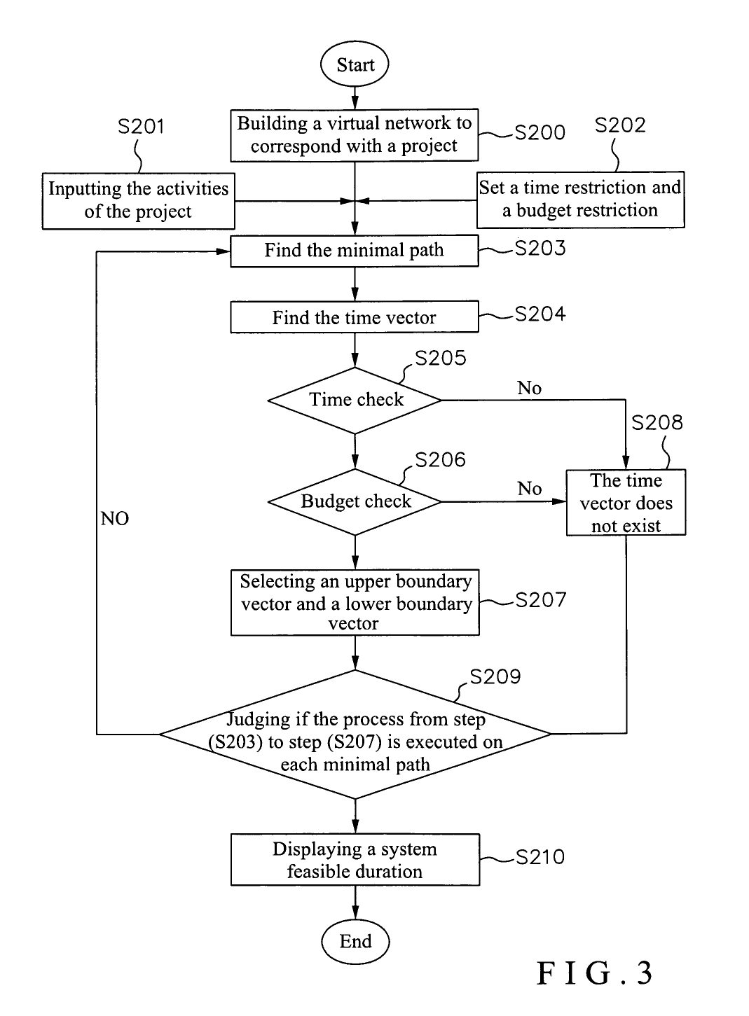

Refer to FIG. 3 for a flow chart of the system feasible duration software 130 executing the system feasible duration evaluation method for project management under budget and time constraints according to the present invention. The method includes the steps of:

Step(S200): building a virtual network to correspond with the project in the network model according to number of the activities in sequence in the project. Wherein the nodes N stands for the state of the activity, each arc ai stands for each activity, each arc ai connects two nodes N, and the unit of the arc is a duration for dealing the activity.

Step(S201): inputting the activities of the pending project from the input unit 110 by user, who uses the system feasible duration evaluation software 130.

Step(S202): receiving a time constraint T and a budget constraint B set by the user.

Step(S203): supposing that the network is a binary-state system, and each arc has two cases of normal and failure. All minimal paths Pⱼ={aj1, aj2, . . . , aⱼₙ_{ⱼ}} between the start node s to the terminal node t in the virtual network are listed. The minimal path is required to be an ordered sequence of the arcs ai between the start node s to the terminal node t without loops. The flow of each minimal path Pⱼ denotes a workload of each activity in each arc ai.

Step(S204): given all the activities ai, the time constraint T and the budget constraint B, investigating the distribution of the feasible duration in the project under the minimal path, defining a time vector X=(x1, x2, . . . , xn) composed of the durations for executing the activities ai, and the values of the time vector are stochastic with different activities ai of the project to correspond with a distribution of the feasible durations in the project.

Step(S205): executing a time check by the operation unit 120 to check if a project time T(X) of dealing the project in each minimal path Pⱼ is less than or equal to the time constraint T for selecting the time vectors X conforming with the project time T(X).

Step(S206): calculating an activity cost of dealing each activity under the time vector X corresponding with the distribution of a certain duration, and a total cost B(X) added the activity costs up. Executing a budget check by the operation unit 120 to check if the total cost B(X) of dealing the activities is less than or equal to the budget constraint B for selecting the time vectors X conforming with the total cost B(X).

Step(S207): defining the time vector X selected by step (S205) and step (S206) as an upper boundary vector or a lower boundary vector. The upper boundary vector, which is the maximum limit state satisfying the time constraint T and the budget constraint B, is composed of the time vectors satisfying the conditions that the project time T(X) equals to the time constraint T and the total cost B(X) is less than the budget constraint B. The lower boundary vector, which is the minimum limit state satisfying the time constraint T and the budget constraint B, is composed of the time vectors X satisfying the conditions that the total cost B(X) equals to the budget constraint B and the project time T(X) are less than the time constraint T.

Step(S208): the time vector X not selected by step (S205) and step (S206) being unqualified for the candidate of the lower boundary vector or the upper boundary vector.

Step(S209): judging if the process from step (S203) to step (S208) is executed on each minimal path, yes for performing step (S210), no for executing this process for the next minimal path.

Step(S210): due to many possibilities of the lower boundary vector and the upper boundary vector calculated in step (S207), list all the time vectors X of each minimal path in the virtual network. If the vector X is less than or equal to the upper boundary vector, and larger than or equal to the lower boundary vector, then define the time vector X as a system feasible duration of the project. Apply state-space decomposition to calculate the probability of the time vector X less than or equal to the upper boundary vector, and larger than or equal to the lower boundary vector; and display the system feasible duration on the output unit 150.

Refer to FIG. 1 for a benchmark network to illustrate the proposed algorithm for executing the system feasible duration evaluation method for project management under budget and time constraints. The algorithm and an embodiment are presented in following text.

The virtual network of the project is composed a graph by the nodes and the arcs. With using the AOA form, the arc of the virtual network represents the activity of the project, and the node of the virtual network represents the state of the activity. The minimal path in network analysis stands for the possible critical path in project management, where the minimal path between the start node s to the terminal node t.

Let n denotes the number of activities of the project, aᵢ denotes the i-th activity, where i=1, 2, . . . , n. Let Z≡(z₁, z₂, . . . , zₙ) denotes the pseudo time vector, D≡(d₁, d₂, . . . , dₙ) denotes the pseudo cost vector, C≡(c₁, c₂, . . . , cₙ) denotes the cost vector and X≡(x₁, x₂, . . . , xₙ) denotes the time vector, which means the distribution of the feasible duration in the project, where zᵢ denoting the i-th pseudo activity duration, dᵢ denoting the i-th pseudo activity cost, cᵢ denoting the i-th activity cost, and xᵢ denoting the i-th activity duration, which means the time needed to complete activity. Let u, denotes the i-th maximum duration and li denotes the i-th minimum duration, so uᵢ≦xᵢ≦li. Let Wi denotes the i-th maximum activity cost.

Let m denotes the number of minimal paths, Pⱼ={aj1, aj2, . . . , aⱼₙ_{ⱼ}}denotes the j-th minimal path, where j=1, 2, . . . , m, so nj denotes number of the arcs in the j-th minimal path Pⱼ. Let M(P_{J}) denotes the maximum activity duration in the j-th minimal path Pⱼ, i.e.

$$M ( {P}_{j} ) = {\sum }_{k = 1}^{{n}_{j}} {u}_{jk} .$$

Let T(X) denotes the project time under the time vector X, B(X) denotes the total cost of the project under the time vector X, T denotes the required time of the project (the deadline to complete the project), and B denotes the budget of the project.

The character of the project is the project time and its corresponding budget having a strong negative relationship. Generally, the total cost increases as the shortening of the project time; on the contrary, the project time increases if decreasing the total cost. The project manager completes the project within the time constraint T by request, and the total cost is limit under the budget constraint B. For getting the request of the time constraint, the activity should be earlier completed but the activity cost decreasing; for limiting the budget, the activity should be delayed so the project is unable to completed in time.

For the project manager, arranging the distribution of the feasible duration is needed, which means selecting the time vector X satisfying the time constraint T(X)≦T and the budget constraint B(X)≦B. For convenience, such the time vector X is called to satisfy the pattern (T, B).

Apparently, enumerating all time vectors X is not a wise way, and is not a good message presenting for the deciders. Hence, proposing a concept about the upper boundary vectors and the lower boundary vectors is a feasible way, and all time vectors X between the upper boundary vectors and the lower boundary vectors means the arrangement of all feasible durations.

The certain time vector X is defined to be the upper boundary vector for satisfying the time constraint T(X)=T and the budget constraint B(X)≦B if X satisfies (T, B) and T(Y)>T for each time vector Y with Y>X. Similarly, another certain time vector X is defined to be the lower duration vector for satisfying the time constraint T(X)≦T and the budget constraint B(X)=B if X satisfies (T, B) and B(Y)>B for each time vector Y such that Y<X. Any time vector between the lower boundary vector and the upper boundary vector satisfies (T, B). That is, selecting all lower boundary vectors and all upper boundary vectors means getting the distribution of the time vectors X for (T, B).

In order to generate all upper boundary vectors and all lower boundary vectors for (T, B), the assumption of the proposed algorithms is as follows:

1. Activity duration xᵢ is a random variable which takes possible values: xᵢ₁<xᵢ₂< . . . <cᵢᵤ_{ᵢ} with a probability distribution, and its corresponding cost cᵢ takes values: cᵢ₁>cᵢ₂> . . . >cᵢᵤ_{ᵢ}. In other words, activity cost cᵢ is a random variable which takes possible values: cᵢ₁>cᵢ₂> . . . >cᵢᵤ_{ᵢ}, with the same probability distribution.

2. Different activity durations are statistically independent.

3. Suppose the pseudo time vector Z=(z₁, z₂, . . . , zₙ) and the pseudo cost vector D=d₁, d₂, . . . , dₙ), respectively. Note that each z₁ takes value from {xᵢ₁, xᵢ₁+1, xᵢ₁+2, . . . } but xᵢ takes value from {xᵢ₁, xᵢ₂, . . . , xᵢᵤ_{ᵢ}}. Similarly, dᵢ takes value from {cᵢᵤ_{ᵢ}, cᵢᵤ_{ᵢ}+1, cᵢᵤ_{ᵢ}+2, . . . } but xᵢ takes value from {cᵢᵤ_{ᵢ}, cᵢ₍ᵤ_{ᵢ}₋₁₎, . . . , cᵢ₁}.

Above all, the algorithm to evaluate the system feasible duration is as follows:

Step 1: For each minimal path Pⱼ={aj 1, aj2, . . . , aⱼₙ_{ⱼ}}, generate all upper boundary vectors for (T, B).

1. Find all pseudo time vectors Z=(z₁, z₂, . . . , zₙ) satisfying constraints (1) & (2).

$$\begin{matrix}{\sum }_{{a}_{i} ∈ {P}_{j}}^{ } {z}_{i} = T \\ for j = 1 , 2 , … , m & ( 1 ) \\ {z}_{i} \geq {x}_{i 1} \\ for i = 1 , 2 , … , n & ( 2 )\end{matrix}$$

2. For each Z, find the maximum time vector X=(x₁, x₂, . . . , xₙ) such that X≦Z as follows:

$${x}_{i} = \{ \begin{matrix}{x}_{ip} & if {x}_{ip} \leq {z}_{i} < {x}_{i ( p + 1 )} \\ {x}_{{iu}_{i}} & if {x}_{{iu}_{i}} \leq {z}_{i} ,\end{matrix} \\ i = 1 , 2 , … , n . \qquad ( 3 )$$

3. Check each X whether its total cost B(X) exceeds the budget B. If yes, delete X.
4. Suppose the remainder is {X₁, X₂, . . . , X_{w}}, and remove those non-maximal ones from {X₁, X₂, . . . , X_{w}} to obtain the set of upper boundary vectors for (T, B) as follows.

4.1 I=φ(I is the stack which stores the index of each non-maximal X after checking. Initially, I=φ.);

4.2 For i=1 to w and i∉I;

4.3 For j=i+1 to w with j∉I;

4.4 If Xᵢ≦Xⱼ, I=I∪{i}; and go to step 4.7 else if Xⱼ>Xᵢ, I=I∪{j};

4.5 j=j+1;

4.6 Xᵢ is an upper duration vector for (T, B); and

4.7 i=i+1.

Step 2: For each minimal path Pj={aj1, aj2, . . . , aⱼₙ_{ⱼ}}, generate all lower boundary vectors for (T, B).

1. Find all pseudo cost vectors D=(d₁, d₂, . . . , dₙ) satisfying constraints (4) & (5).

d₁+d₂+ . . . +dₙ=B (4)

dᵢ≦cᵢᵤ_{ᵢ} for i=1, 2, . . . , n (5)

2. For each D=(d₁, d₂, . . . , dₙ), find the maximum cost vector C=(c₁, c₂, . . . , cₙ) such that C≦D as follows:

$${c}_{i} = \{ \begin{matrix}{c}_{ip} & if {c}_{i ( p - 1 )} > {d}_{i} \geq {c}_{ip} \\ {c}_{i 1} & if {d}_{i} \geq {c}_{i 1} ,\end{matrix} \\ i = 1 , 2 , … , n . \qquad ( 6 )$$

3. Transform each C to the corresponding X=(x₁, x₂, . . . , xₙ) and check whether T(X)>T. If yes, delete X.
4. Suppose the remainder is {X₁, X₂, . . . , Xᵥ}, and remove those non-minimal ones from {X₁, X₂, . . . , Xᵥ}. The remainder is the set of lower boundary vectors for (T, B).

Use the benchmark network in FIG. 1 to illustrate the proposed algorithm. The project composed of five activities is represented as the virtual network with five arcs and four nodes. The project manager is required to complete the project within 10 weeks and within the budget US$ 1400. The data of activity durations and activity costs are listed in Table 1. It is known in FIG. 1 that there are three minimal paths: P₁={a₁, a₂}, P₂={a₁, a₃, a₅} and P₃={a₄, a₅}. All upper boundary vectors for (10, 1400) and lower boundary vectors for (10, 1400) are obtained by the following procedure, respectively.

TABLE 1
Data of duration and cost of FIG. 1

| | Duration | Activity |
|---|---|---|
| Activity | (weeks) | cost (US$) |
| α₁ | 2 | 400 |
| | 4 | 300 |
| | 6 | 200 |
| α₂ | 3 | 350 |
| | 4 | 250 |
| | 5 | 150 |
| α₃ | 1 | 400 |
| | 3 | 200 |
| | 4 | 200 |
| α₄ | 2 | 350 |
| | 4 | 250 |
| | 6 | 150 |
| α₅ | 3 | 400 |
| | 5 | 300 |
| | 7 | 200 |

Step 1: Generate all upper boundary vectors for (T, B).

1. Find all feasible solutions Z=(z₁, z₂, z₃, z₄, z₅) of constraints (7) & (8).

$$\begin{matrix}\{ \begin{matrix}{z}_{1} + {z}_{2} = 10 \\ {z}_{1} + {z}_{3} + {z}_{5} = 10 \\ {z}_{4} + {z}_{5} = 10\end{matrix} & ( 7 ) \\ {z}_{1} \geq 2 , \\ {z}_{2} \geq 3 , \\ {z}_{3} \geq 1 , \\ {z}_{4} \geq 2 , \\ {z}_{5} \geq 3 & ( 8 )\end{matrix}$$

2.˜4. The results are shown in Table 2. Obtain 5 upper boundary vectors for (10,2800): X̅₁̅=(2,5,3,4,5), X̅₂̅=(2,5,4,6,3) X̅₃̅=(4,5,1,4,5), X̅₄̅=(4,5,3,6,3) and X̅₅̅=(6,4,1,6,3).

TABLE 2
The results of Algorithm I for the numerical example.

| Pseudo duration | Duration | | Is an upper duration |
|---|---|---|---|
| vector Z | vector X | B(X) | vector for (10, 1400)? |
| (step 1) | (step 2) | (step 3) | (step 4) |
| (2, 8, 1, 3, 7) | (2, 5, 1, 2, 7) | 1500* | NO (B(X) > 1400) |
| (2, 8, 2, 4, 6) | (2, 5, 1, 4, 5) | 1500* | NO (B(X) > 1400) |
| (2, 8, 3, 5, 5) | (2, 5, 3, 4, 5) | 1400(X₁) | YES ( x̅₁̅) |
| (2, 8, 4, 6, 4) | (2, 5, 4, 6, 3) | 1300(X₂) | NO (X₂ ≦ X₅) |
| (2, 8, 5, 7, 3) | (2, 5, 4, 6, 3) | 1300(X₃) | NO (X3 ≦ X₅) |
| (3, 7, 1, 4, 6) | (2, 5, 1, 4, 5) | 1500* | NO (B(X) > 1400) |
| (3, 7, 2, 5, 5) | (2, 5, 1, 4, 5) | 1500* | NO (B(X) > 1400) |
| (3, 7, 3, 6, 4) | (2, 5, 3, 6, 3) | 1400(X₄) | NO(X₄ ≦ X₅) |
| (3, 7, 4, 7, 3) | (2, 5, 4, 6, 3) | 1300(X₅) | YES ( x̅₂̅) |
| (4, 6, 1, 5, 5) | (4, 5, 1, 4, 5) | 1400(X₆) | YES ( x̅₃̅) |
| (4, 6, 2, 6, 4) | (4, 5, 1, 6, 3) | 1400(X₇) | NO (X₇ ≦ X₈) |
| (4, 6, 3, 7, 3) | (4, 5, 3, 6, 3) | 1300(X₈) | YES ( x̅₄̅) |
| (5, 5, 1, 6, 4) | (4, 5, 1, 6, 3) | 1400(X₉) | NO (X₉ ≦ X₈) |
| (5, 5, 2, 7, 3) | (4, 5, 1, 6, 3) | 1400(X₁₀) | NO (X₁₀ ≦ X₈) |
| (6, 4, 1, 7, 3) | (6, 4, 1, 6, 3) | 1400(X₁₁) | YES ( x̅₅̅) |

*B(X) > 1400

Step 2: Generate all lower boundary vectors for (T, B).

1. Find all D=(d₁, d₂, d₃, d₄, d₅) satisfying (9) & (10).

d₁+d₂+d₃+d₄+d₅=1400 (9)

d₁≧200, d₂≧150, d₃≧200, d₄≧150, d₅≧200 (10)

2.˜4. Obtain nine lower boundary vectors for (10, 1400): X₁=(6,4,1,6,3), X₂=(4,5,3,4,3), X₃=(4,5,1,6,3), X₄=(4,5,1,4,5), X₅=(4,4,3,6,3), X₆=(2,5,4,4,3), X₇=(2,5,3,6,3), X₈=(2,5,3,4,5) and X₉=(2,4,4,6,3).

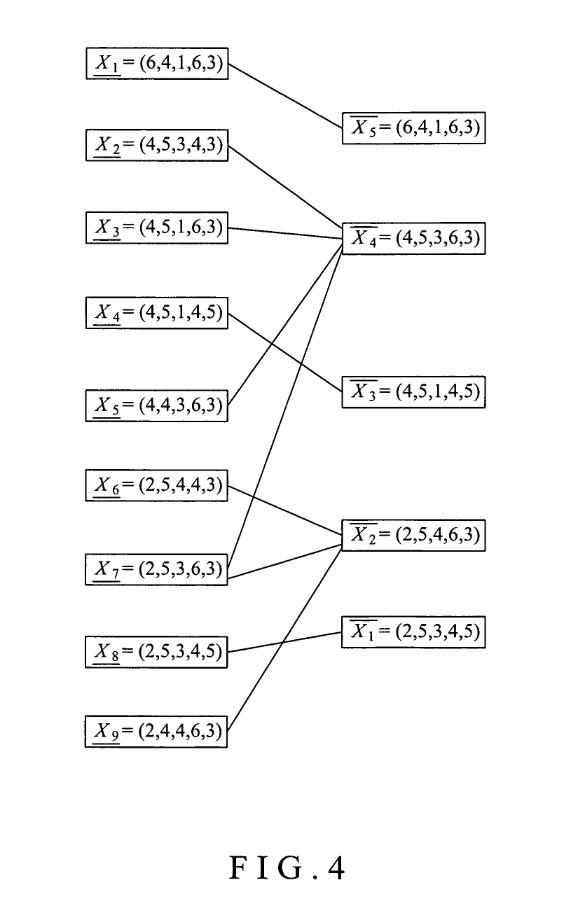

Refer to FIG. 4 for the relationships showing among all upper boundary vectors and all lower boundary vectors for (10, 1400). If the time vector X is scheduled to be (3,5,3,6,3), then there exists the upper boundary vector X̅₄̅=(4,5,3,6,3) and the lower boundary vector X₇=(2,5,3,6,3) such that X̅₄̅>X>X₇. In other words, (3,5,3,6,3) is a feasible solution subject to the project under time and budget constraints.

Actually, the present method is suitable for the project manage with time and budget constraints. From the point of quality management, the system feasible duration is able to be regarded as a performance index.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present is invention as defined by the following claims. Moreover, no element and component in the present disclosure is intended to be dedicated to the public regardless of whether the element or component is explicitly recited in the following claims.

What is claimed is:

1. A system feasible duration evaluation method for project management under budget and time constraints, using a computer containing an input unit, an operation unit and an output unit to execute a feasible duration evaluation software which provides a virtual network for simulating a project, the virtual network having a start node, a terminal node and plural arcs, wherein the unit of the arc is a duration and the arcs are located between the start node and the terminal node for constituting plural minimal paths, the method comprising the steps of:
inputting a plurality of activities of the project, a budget constraint and a time constraint from the input unit by users of the feasible duration evaluation software;
distributing orderly the activities in the virtual network;
defining a time vector composed of the durations of the arcs, and the durations, wherein the value of the time vector is stochastic to correspond with a distribution of the feasible durations in the project;
executing a time check by the operation unit to check if an activity duration of completing each activity is less than or equal to the time constraint, in order to find time vectors satisfying the activity duration;
executing a budget check by the operation unit to check if a total cost of completing all the activities of the project is less than or equal to the budget constraint, in order to find time vectors satisfying the total cost;
defining an upper boundary vector composed of the time vectors satisfying the conditions that all the activity durations equal to the time constraint and the total cost less than the budget constraint;
defining a lower boundary vector composed of the time vectors satisfying the conditions that the total cost is equal to the budget constraint and the activity durations are less than the time constraint; and
listing the time vector for one of the minimal paths in the virtual network less than or equal to the upper boundary vector and larger than or equal to the lower boundary vector, and defining the time vector as a system feasible duration of the project; and
displaying the system feasible duration on the output unit.

2. The system feasible duration evaluation method for project management under budget and time constraint of claim 1, wherein the step of distributing orderly the activities in the virtual network comprises:
listing the minimal paths of the virtual network, wherein each of the minimal paths is an sequence of the arcs from the start node to the terminal node without loops.

3. The system feasible duration evaluation method for project management under budget and time constraint of claim 1, wherein the step of executing a time check comprises:
calculating the activity duration for completing each activity in each of the minimal paths;
comparing the values of the activity durations and the time constraint to obtain a comparison result; and
according to the comparison result, judging if the time vector for one of the minimal paths exists or not.

4. The system feasible duration evaluation method for project management under budget and time constraint of claim 1, wherein the step of executing a budget check comprises:
calculating an activity cost of dealing each of the activities under time vector, and the total cost added the activity costs up;
comparing the values of the total cost and the budget constraint to obtain a comparison result; and
according to the comparison result, judging if the time vector for one of the minimal paths exists or not.

5. The system feasible duration evaluation method for project management under budget and time constraint of claim 1, further comprising:
calculating the probability of the system feasible duration by state-space decomposition.
